(19) United States
(12) Patent Application Publication
(10) Pub. No.: US 2005/0160858 A1
(43) Pub. Date: Jul. 28, 2005

(54) Shape memory alloy actuator

(75) Inventor: Morten Mernoe, Charlottenlund (DK)

Correspondence Address: KLEIN, O'NEILL & SINGH, 2 PARK PLAZA, SUITE 510, IRVINE, CA, 92614, US

(73) Assignee: M 2 MEDICAL A/S, Gentofte (DK)

(21) Appl. No.: 11/041,188

(22) Filed: Jan. 21, 2005

Related U.S. Application Data
(63) Continuation of application No. PCT/DK03/00508, filed on Jul. 21, 2003.

(30) Foreign Application Priority Data
Jul. 24, 2002 (DK) PA 2002 01134

(51) Int. Cl. G05G 1/00

(52) U.S. Cl. 74/469

(57) ABSTRACT

An actuator includes a body displaceable between first and second positions, a holding mechanism for holding the body in the first position, and first and second shape memory alloy wires, the first wire being connected to the body, such that shortening the first wire moves the body from the second position to the first position. A biasing element biases the body for moving it from the first to the second position, the second wire having one end connected to the holding mechanism, such that shortening the second wire releases the holding mechanism for allowing the biasing element to move the body from the first position to the second position. An intermediate lever has one arm attached to the biasing element, and the other arm abutting a projection on the body, such that the force of the biasing element is transmitted to the body by the lever.

The present invention relates to a shape memory alloy actuator comprising a body arranged displaceable between a first and a second position, releasable holding means adapted for holding said body in said first position, and at least one first and at least one second wire made of a shape memory alloy such as nitinol, said first wire being at one end connected to said body such that shortening of the length of said first wire exerts a force on said body for moving said body from said second to said first position.

It is an object of the invention to provide a shape memory alloy actuator that is cheap to manufacture and efficient in use and this object is achieved by the actuator further comprising a biasing means, such as a tension spring, a compression spring, a straight or arcuate flat spring or a piston and cylinder mechanism, arranged and adapted for biasing said body for moving said body from said first to said second position, said second wire having one end connected to said holding means such that shortening of the length of said second wire releases said holding means for allowing said biasing means to move said body from said first position to said second position.

So as to obtain an actuator which is mechanically efficient and is protected against damage of the shape memory alloy wire said body is displaceably attached to a frame, one end of each of said first and second wires is attached to said frame and connected at the other end thereof with said body and said pawl, respectively, such that shortening of the length of said first wire exerts a displacing force on said body in a first direction and shortening of the length of said second wire exerts a pivoting force on said pawl in the direction from said holding position towards said release position, and said biasing means is attached to said frame and arranged for exerting a displacing force on said body in a second direction opposite said first direction and wherein said biasing means is arranged and adapted to exert a rotation force on a rotatably arranged intermediate member such as a lever or a disc for rotating said intermediate member around an axis of rotation in a first direction of rotation from a first angular position to a second angular position, said intermediate member being connected to said body at a force transmission point such that rotation of said intermediate member in said first direction of rotation displaces said body in said second direction, said biasing means and said intermediate member being arranged and adapted such that the lever or moment arm of said rotation force with respect to said axis of rotation is larger when said intermediate member is in said second angular position than when said intermediate member is in said first angular position such that said lever or moment arm of said rotation force increases when said intermediate member rotates in said first direction of rotation, and/or said intermediate member and said body being arranged and adapted such that said rotation force is transmitted to said body as a displacement force applied at said force transmission point for moving said body from said first to said second position, and such that the lever or moment arm of said displacement force with respect to said axis of rotation is larger when said intermediate member is in said first angular position than when said intermediate member is in said second angular position such that said lever or moment arm of said displacement force with respect to said axis of rotation decreases when said intermediate member rotates in said first direction of rotation.

The present invention furthermore relates to a shape memory alloy actuator comprising a body arranged displaceable between a first and a second position, at least one first wire made of a shape memory alloy such as nitinol, said first wire being at one end connected to said body such that shortening of the length of said first wire exerts a force on said body for moving said body from said second to said first position, a biasing means, such as a tension spring, a compression spring, a straight or arcuate flat spring or a piston and cylinder mechanism, and a rotatably arranged intermediate member such as a lever or a disc connected to said body and to said biasing means, said biasing means being adapted for exerting a rotation force on said intermediate member for rotating said intermediate member around an axis of rotation in a first direction of rotation from a first angular position to a second angular position, said intermediate member being connected to said body such that rotation of said intermediate member in said first direction of rotation displaces said body from said first position to said second position, and said biasing means and said intermediate member being arranged and adapted such that the lever or moment arm of said rotation force with respect to said axis of rotation is larger when said intermediate member is in said second angular position than when said intermediate member is in said first angular position such that said lever or moment arm of said rotation force increases when said intermediate member rotates in said first direction of rotation.

Hereby a variable leveraging of the contraction force of the shape memory alloy wire is obtained as well as a variable leveraging of the activating displacement force of the biasing means such that an efficient utilization of the SMA wire is obtained, the SMA wire is protected against damage or snapping if the activated object is blocked, and an activating force is applied that increases as the activation proceeds while the force exerted by the SMA wire is decreases as the SMA shortens when heated to the transformation temperature of the shape memory alloy.

These advantages may alternatively or additionally be achieved by means of a memory alloy actuator comprising a body arranged displaceable between a first and a second position, at least one first wire made of a shape memory alloy such as nitinol, said first wire being at one end connected to said body such that shortening of the length of said first wire exerts a force on said body for moving said body from said second to said first position, a biasing means, such as a tension spring, a compression spring, a straight or arcuate flat spring or a piston and cylinder mechanism, and a rotatably arranged intermediate member such as a lever or an arm connected to said body at a force transmission point on said body and connected to or integral with said biasing means, said biasing means being adapted for exerting a rotation force on said intermediate member for rotating said intermediate member around an axis of rotation in a first direction of rotation from a first angular position to a second angular position, said intermediate member being connected to said body such that rotation of said intermediate member in said first direction of rotation displaces said body from said first position to said second position, and said intermediate member and said body being arranged and adapted such that said rotation force is transmitted to said body as a displacement force applied at said force transmission point for moving said body from said first to said second position, and such that the lever or moment arm of said displacement force with respect to said axis of rotation is larger when said intermediate member is in said first angular position than when said intermediate member is in said second angular position such that said lever or moment arm of said displacement force with respect to said axis of rotation decreases when said intermediate member rotates in said first direction of rotation.

In another aspect, the present invention relates to a shape memory alloy motor comprising a shape memory alloy actuator, preferably according to any of the previous claims, having a body arranged displaceable between a first and a second position, at least one first wire made of a shape memory alloy such as nitinol, said first wire being at one end connected to said body such that shortening of the length of said first wire exerts a first displacement force on said body for moving said body from said second to said first position, a biasing means, such as a tension spring, a compression spring, a straight or arcuate flat spring or a piston and cylinder mechanism arranged and adapted for exerting a second displacement force on said body for moving said body from said first to said second position, a gear having a first and second rotation direction, said body having a portion adapted to fit between two adjacent teeth of said gear, and said body and said gear being adapted and arranged such that in said first position said portion is located between a pair of teeth of said gear and in said second position said portion is located between the adjacent pair of teeth of said gear reckoned in said second rotation direction of said gear such that said second displacement force will cause said body to rotate said gear in said first direction.

In a final aspect the present invention relates to a shape memory alloy motor comprising a shape memory alloy actuator, preferably according to any of the previous claims, having a body arranged displaceable between a first and a second position, at least one first wire made of a shape memory alloy such as nitinol, said first wire being at one end connected to said body such that shortening of the length of said first wire exerts a first displacement force on said body for moving said body from said second to said first position, a biasing means, such as a tension spring, a compression spring, a straight or arcuate flat spring or a piston and cylinder mechanism arranged and adapted for exerting a second displacement force on said body for moving said body from said first to said second position, a rack having a first and second displacement direction, said body having a portion adapted to fit between two adjacent teeth of said rack, and said body and said rack being adapted and arranged such that in said first position said portion is located between a pair of teeth of said rack and in said second position said portion is located between the adjacent pair of teeth of said gear reckoned in said second displacement direction of said rack such that said second displacement force will cause said body to displace said rack in said first direction.

The various aspects of the invention will be described more in detail in the following with reference to various embodiments of a shape memory alloy actuator according to the invention shown, solely by way of example, in the accompanying drawings, where

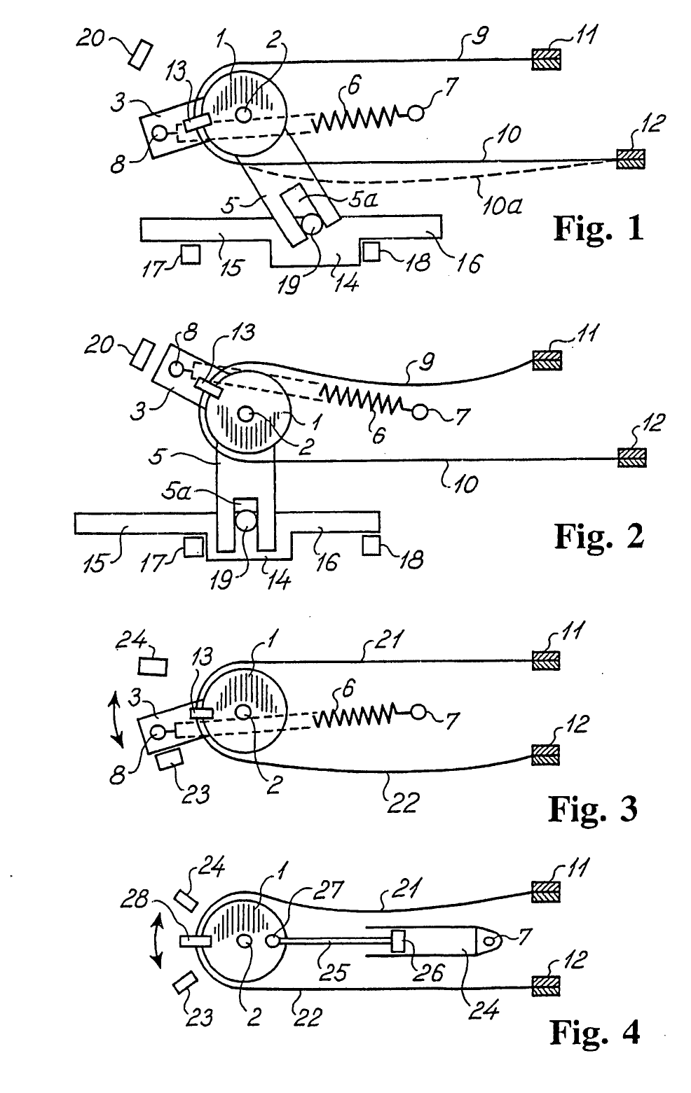

FIGS. 1 and 2 are schematic illustrations of a first embodiment of an actuator according to the invention in two different positions, namely with the activating pin fully retracted in FIG. 1, and with the activating pin fully extended in FIG. 2,

FIGS. 3 and 4 are schematic illustrations of a second and third embodiment, respectively, of an actuator according to the invention,

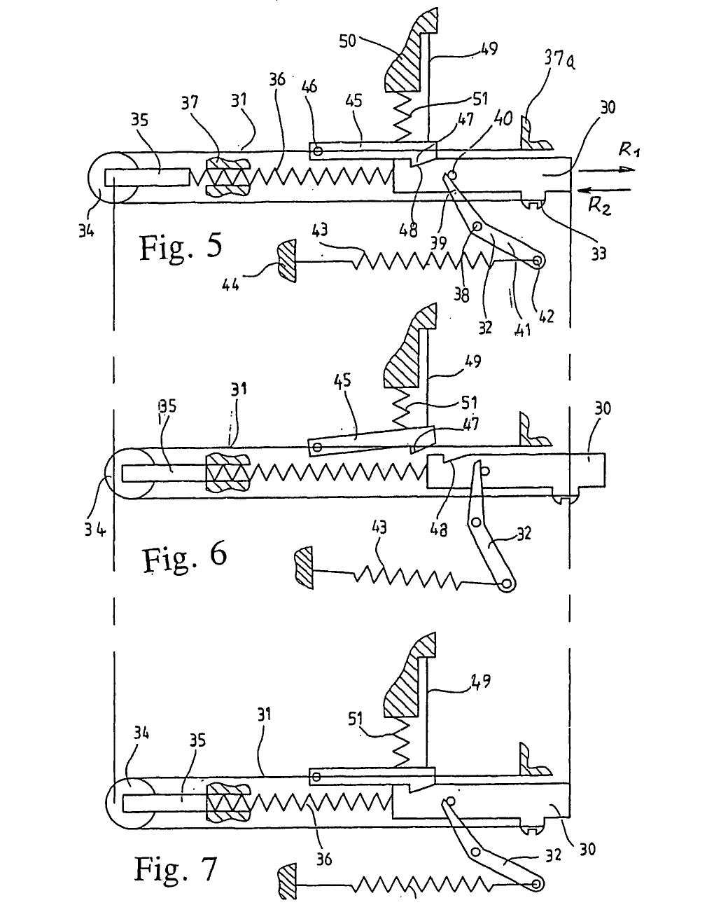

FIGS. 5-7 are schematic illustrations of three stages in the operation of a fourth embodiment of an actuator according to the invention,

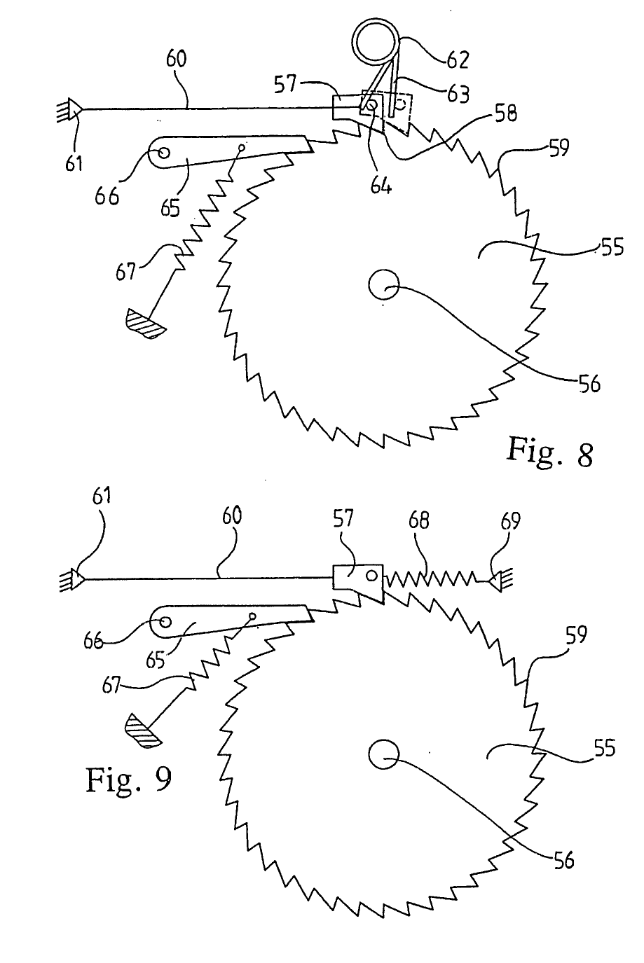

FIG. 8 is a schematic illustration of a first embodiment of a shape memory alloy actuator motor according to the invention,

FIG. 9 is a schematic illustration of a second embodiment of a shape memory alloy actuator motor according to the invention,

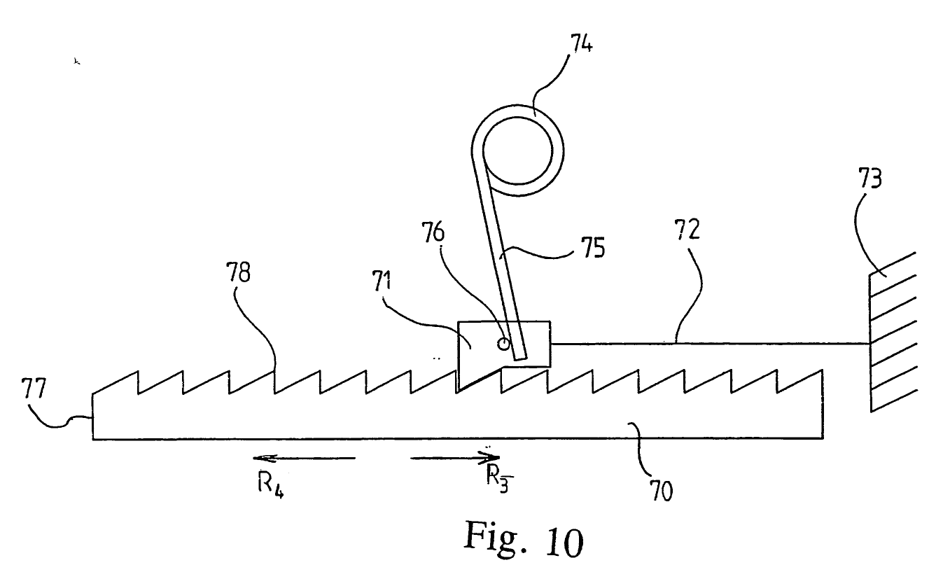

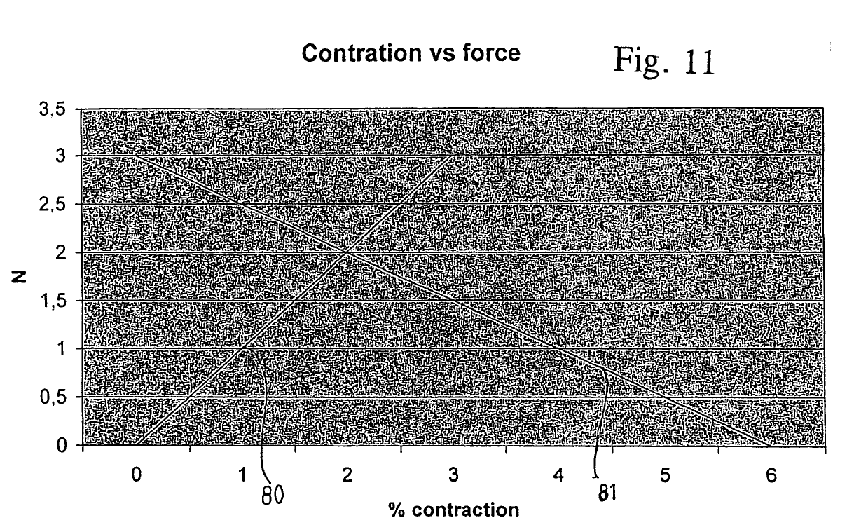

FIG. 10 is a schematic illustration of a rack type linear shape memory alloy actuator according to the invention,

FIG. 11 is a graph showing two curves of Contraction versus Force for shape memory alloy wires for different biasing systems for the actuators according to the invention, and

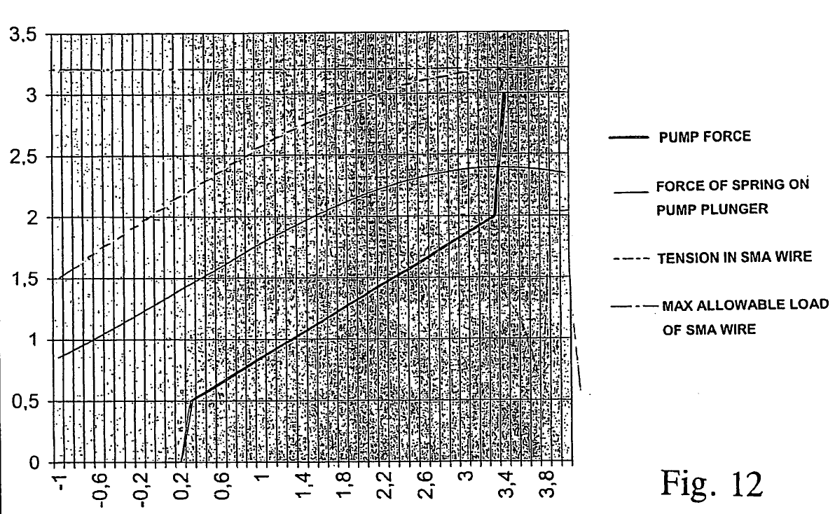

FIG. 12 is a graph showing the relationship between various forces in Newton and the distance of displacement of a piston pump plunger in mm by the actuator shown in FIGS. 5-7.

Referring now to FIGS. 1 and 2, a pivotable body in the form of a circular disc 1 is arranged for pivoting around a central pivot 2 fixedly attached to a not shown frame of the actuator, and the disc 1 is provided with a peripheral extension 3 and a yoke-like peripheral extension 5. A tension coil spring 6 is at one end thereof pivotably attached to a fastening pin 7 fixedly attached to said frame and is at the other end thereof pivotably attached to a fastening pin 8 fixedly attached to the peripheral extension 3. Two wires or filaments 9 and 10 of a shape memory alloy such as nickel titanium alloy or nitinol, for instance supplied by the company DYNALLOY, INC, of Costa Mesa, Calif., USA, under the trade name FLEXINOL, are attached at one end thereof to electrically conductive terminals 11 and 12, respectively, fixedly attached to said frame.

The other end of each of the wires 9 and 10 is attached to an electrically conductive terminal 13 fixedly attached to the periphery of the disc 1. The wires 9 and 10 extend along the periphery of the disc 1 such that the wires 9 and 10 when tensioned extend along and are supported by said periphery. In the drawings the wires 9 and 10 are shown spaced from said periphery for the sake of clarity.

A sliding body 14 having two arms 15 and 16 is arranged for sliding movement between two stop pins 17 and 18 attached to the frame. A pin 19 attached to the sliding body 14 is received in the fork 5a of the yoke-like extension 5 such that the pin 19 may slide and rotate freely in the fork when the disc 1 pivots from the position shown in FIG. 1 to the position shown in FIG. 2 thereby slidingly displacing the body 14 from abutment against stop pin 18 to abutment against stop pin 17 with the arm 15, constituting the activating pin of the actuator, fully extended.

A proximity sensor 20 is attached to the frame and connected to not shown electrical conductors for transmitting a signal from the sensor to a not shown receiver. The terminals 11 and 12 are likewise each connected to an electrical conductor, not shown, connected to a not shown power source for supplying electrical power to the wires 9 and 10 for resistance heating thereof, the terminal 13 being likewise connected to the not shown power source through a not shown electrical conductor for closing the resistance heating circuit.

In use, the wires 9 and 10 are intermittently heated to the transformation or transition temperature (from martensitic to austenitic state) of the shape memory alloy which temperature for nitinol is approximately 90° C. Thereby the length of the wire is shortened. When the wire cools to below 90° C. the length thereof reverts to normal, i.e. the wire lengthens. The speed at which the shortening takes place, i.e. the contraction time, is directly related to the current input. i.e. the voltage applied over the terminals 11 or 12 and 13.

In the position depicted in FIG. 1, the intermediate disc 1 is in its outermost counter clock-wise position with the arm 15 fully retracted and with the wire 9 cooled to below 90° C. and the wire 10 heated to above 90° C. by applying an electrical voltage between the terminal 12 and 13 whereby an electrical current will flow through the wire 10. The disc 1 has therefore been rotated counter clock-wise to the position shown by the contraction force exerted by the wire 10.

In the next step, the wire 10 is cooled to below 90° C. and thereby lengthens to the shape indicated by the dotted line 10a in FIG. 1. The actuator is now ready to perform an activating extension of the arm 15 towards the left, the end of the arm 15 being intended to come into contact with a not shown lever, plunger, button or the like and depress or activate same during the movement of the arm 15 to the extended leftwards position thereof as depicted in FIG. 2.

Thereafter or simultaneously, the wire 9 is heated to above 90° C. whereby it contracts and exerts a clock-wise force on the disc 1 pivoting it clock-wise around the pivot 2 past the balance position of the disc 1 and spring 6 in which the attachment pins 7 and 8 of the spring 6 are aligned with the pivot 2.

When the disc 1 has rotated clock-wise past said balance point, the tension force exerted by the spring 7 will continue the clock-wise rotation of the disc 1 to the position shown in FIG. 2 with the arm 15 fully extended and the wire 9 slack though still above 90° C. This is the actual activating movement of the actuator where the force applied to the sliding body 14 by the extension 5 increases because of the increasing lever of force or moment arm of the tension force exerted by the spring 6 on the intermediate disc 1 with respect to the pivot 2 or axis of rotation of the disc 1.

For many applications where the force necessary to perform the function of the actuator, for instance depress a pump piston, increases during the activating stroke, said increase of the spring force moment arm as the disc 1 rotates is a very advantageous feature as will be explained more in detail in connection with FIGS. 11 and 12 in the following.

An increase of the activating force of the actuator during the activating stroke is also achieved or enhanced by decreasing the distance of the pin 19 from the pivot 2 or axis of rotation of the disc 1 during the activating stroke whereby the moment arm or lever of force of the displacement force exerted on the pin 19 by the yoke-like extension 5 with respect to the pivot 2 is decreased and thereby the displacement force is increased during the activating stroke. This shortening of said distance can be seen from the situation in FIG. 1 at the beginning of the activation stroke to the situation in FIG. 2 at the end of the activation stroke.

Finally, the wire 10 is heated above 90° C. so that it contracts and pivots the disc 1 back to the position shown in FIG. 1 whereby the activating cycle is ready to be repeated.

The length of the wire 10 is larger than the length of the wire 9 because the contraction or shortening of the wire 10 must be large enough to pivot the disc 1 from the position shown in FIG. 2 past the balance point mentioned above while the shortening of the wire 9 only has to be enough the pivot the disc 1 from the position shown in FIG. 1 past said balance point.

Nitinol wires will typically contract about 3%-6% when heated past the transition temperature. The uncontracted length of the wire 10 should be enough to ensure that the uncontracted wire is fully extended in the position shown in FIG. 2 and that the contracted wire 10 is fully extended when the disc 1 is at least slightly past said balance point in the counter-clockwise direction, i.e. the uncontracted length of wire 10 should be about 22-25 times the distance of travel of terminal 13 between the FIG. 2 position thereof and the balance point position thereof.

The necessary contraction force to be exerted by wires 9 and 10 are rather different because the contraction force of wire 9 only has to counteract the torque or moment of the spring force of spring 6 with the relatively small torque arm in FIG. 1 while the contraction force of wire 10 has to counteract the considerably larger torque of said spring force in FIG. 2. The contraction force of a nitinol wire is larger the larger the diameter or cross sectional area of the wire. The cross sectional area of wire 10 is thus considerably larger than the cross sectional area of wire 9 or there may be a number of wires 10 with the same cross sectional area.

The latter possibility is chosen if it is necessary that the cooling-off time for the wires 10 is as short of possible so that the interval between the activating cycles may be as short as possible. Several small diameter wires with a certain total cross sectional area will cool more rapidly than a single larger diameter wire with the same cross sectional area.

The signal emitted by the proximity sensor 20 each time the extension 3 is in the position shown in FIG. 2 may be utilized for many different purposes such as for instance a mere monitoring of the correct function of the actuator or for controlling the timing of the heating of the wires 9 and 10 and thereby the timing of the activating stroke of the sliding body 14. Naturally, the location of the proximity sensor or of any other type of sensor for sensing the position of the disc 1 may be varied according to the purpose thereof, and several such sensors may be provided in different locations for instance for achieving a more complex control of the timing of the activating effect of the actuator.

Referring now to FIG. 3, this embodiment differs from the embodiment of FIGS. 1-2 in that a double activating effect may be achieved for each cycle of heating and cooling the shape memory wires 21 and 22 that in this case are of equal length and cross sectional area. The rotation of the disc 1 counter-clockwise and clockwise is limited by stop pins 23 and 24, respectively.

The activating member may be a sliding body similar to body 14 in FIG. 1-2 where both the arm 15 and the arm 16 perform an activating function, or the activating function may be a pull/push activation by for instance arm 15.

The disc 1 may alternatively be provided with a central torsion shaft projecting at right angles to the plane of the disc 1 as a prolongation of the pivot 2 such that the torsion shaft functions as the activating member by for instance rotating a lever to and fro. Many different types of activating members connected to the disc 1 will be obvious to those skilled in the art.

In the position shown in FIG. 3, the disc 1 has just performed an activating rotation counter-clockwise under the influence of the counter-clockwise torque of the force of the spring 6 and is ready for the initiation of a rotation clockwise by heating the wire 21 so that the disc 1 is rotated against the counter-clockwise torque of the spring force until the balance point is passed. Then the activating rotation clockwise is performed by the clockwise torque of the spring force. Also in this embodiment the moment arm of the activating force of the spring 6 increases during the activating stroke in both directions.

Referring now to FIG. 4, the terminal 13 of the embodiments of FIGS. 1-3 has been substituted by a combined terminal and abutment member 28 for abutting the stop pins 24 and 25. Furthermore, another type of biasing means is utilized, namely a piston and cylinder mechanism comprising a pressurized cylinder 24 pivotably attached to pin 7, a piston 26 and a piston rod 27 pivotably attached to the disc 1 by means of a pin 27.

The piston and cylinder mechanism 24-25 functions like a compression spring and could in fact be substituted by a compression spring. In FIG. 4 the disc 1 is in the balance point position where the pin 7, the pin 27 and the pivot 2 are aligned such that the pressure exerted on the disc 1 by the piston rod 25 does not produce any torque on the disc 1. In the situation shown in FIG. 4, the wire 22 is contracting and rotating the disc counter-clockwise past the balance point. As soon as the balance point has been passed, the torque from the piston rod 25 will cause the activating counter-clockwise rotation of the disc 1 until the member 28 abuts the stop pin 23 whereupon a clockwise rotation may be initiated in a manner very similar to that described above in relation to FIG. 3.

The tension spring 6 in FIGS. 1-2 could also be substituted by a piston and cylinder mechanism or a compression spring in an arrangement similar to FIG. 4.

Referring now to FIGS. 5-7 an activating body 30 is arranged linearly displaceable in the directions of arrows R1 and R2 under the influence of a shape memory alloy wire 31 and a two-armed lever 32.

One end of the wire 31 is attached to the body 30 at 33 and the other end is attached to a fixed portion 37a of a not shown frame of the actuator, the wire 31 extending around a pulley 34 pivotably arranged on a slide 35 displaceable in the directions of the arrows R1 and R2. A compression spring 36 is arranged between the body 30 and the slide 35 and extends through a passage through a fixed portion 37 of said frame.

The two-armed lever 32 is arranged pivotable around a pivot 38, one arm 39 of the lever abutting a pin 40 on the body 30 and the other arm 41 of the lever being attached at 42 to one end of a tension spring 43, the other end being attached to a fixed portion 44 of said frame such that displacement of the body 30 in the direction of arrow R1 tensions the spring 43 via rotation of the intermediate lever 32.

A pawl or hook element 45 is arranged pivotable around a pivot 46 such that a hook or projection 47 of the hook element 45 may be received in a matching recess 48 in the body 30. A shape memory alloy wire 49 is at one end attached to the hook element 45 and at the other end attached to a fixed portion 50 of said frame. A compression spring 51 is arranged between the fixed portion 50 and the hook element 45

In use, the body 30 is moved to and fro in the direction of the arrows R1 and R2 to actuate a plunger, lever, button, contact and the like during the activating stroke of the body in the direction R1.

In FIG. 5 the wire 31 is cooled to below the transformation temperature of the alloy (for instance by sandwiching the wire between two aluminium rails coated with PTFE) and is at its maximum length and is maintained taut by the biasing action of the compression spring 36. The hook 47 is received in the recess and holds the body 30 against the biasing force of the spring 43 transmitted to the pin 40 by means of the lever 32. The wire 49 is also in its cool state and at its maximum length.

When the activating stroke is to be initiated, the wire 49 is heated to the transformation temperature and shortens or contracts, thereby pivoting the hook element 45 against the biasing force of the spring 51 such that the hook 47 is pulled out of the recess 48 to the release position shown in FIG. 6. The body 30 is thus released for displacement in direction R1 under the influence of the lever 32 pivoted by the spring 43.

During the activating stroke of body 30 in direction R1 the lever or moment arm of the force exerted by the spring 43 relative to the pivot 38 or the axis of rotation of the lever 32 increases such that the displacement force exerted on the pin 40 by the arm 39 increases as the body 30 is displaced in the direction R1.

Likewise, during the activating stroke by the body 30 in direction R1, the lever or moment arm of the displacement force exerted by the arm 39 on the pin 40 relative to the pivot 38 decreases whereby said displacement force increases as the body 30 is displaced in the direction R1.

When the slide 35 abuts the fixed frame portion 37, the activating stroke in direction R1 will be stopped as shown in FIG. 6. In practice the activating stroke preferably is stopped by the resistance to the activating stroke of the body 30 by the object being activated such that the stroke is stopped before the slide 35 abuts the fixed frame portion 37.

So as to cock the actuator again, the wire 49 is cooled to allow the spring 51 to pivot the hook element 45 towards the holding position thereof while the wire 31 is heated until it shortens and thereby causes the slide 35 to abut the fixed frame portion 37 and the pulley 34 to rotate clock-wise while the body 30 is displaced in the direction R2 against the force of the spring 43 that thereby is lengthened while the lever 32 pivots counter clock-wise. When the body 30 has reached the position shown in FIG. 7, the hook 47 is pressed into the recess 48 and the wire 31 may then be cooled so that the situation in FIG. 5 is re-established ready to initiate a new activation cycle of the actuator.

During the tensioning of the spring 43, the force exerted by the wire 31 necessary for this tensioning is largest at the beginning of the displacement of the body 30 in the direction R2 because of the large moment arm of the force of the spring 43 and the small moment arm of the rotation force of the pin 40 on the arm 39, and the force exerted by the wire 31 decreases as the body 30 is displaced in the direction R2. This is an advantageous development of the force in the wire 31 during the cocking of the actuator as will be explained more in detail in the following in connection with FIGS. 11 and 12.

By adapting the actuator according to the invention such that the activating stroke is performed by a force exerted by a biasing means, a further advantage is obtained in that any blocking of the activating stroke of the activating body, for instance because the activated object such as a pump plunger is blocked, will only entail that the activation stroke is stopped with no damage to the SMA wire. If the activating stroke were carried out under the influence of a shortening of a shape memory alloy wire, said wire would probably be damaged or snapped if the activating stroke were blocked.

The extra length of the wire 31 obtained by means of the pulley 34 is advantageous for giving a longer activating stroke with a compact construction of the actuator.

The heating of the wires 31 and 49 is preferably carried out in a manner similar to the heating of the wires 9 and 10 in FIGS. 1-2 by means of not shown electrically conductive connections of the ends thereof to a power source.

Referring now to FIG. 8, a toothed wheel or gear 55 is rotatably arranged on a power output shaft 56 journalled in a not shown frame of the actuator motor. A body 57 having an edge portion 58 fitting between two neighbouring teeth 59 of the gear 55 is arranged in said frame displaceable between the position shown in full lines and the position shown in dotted lines.

A shape memory alloy wire 60 is at one end attached to the body 57 and at the other end to a fixed portion 61 of said frame. A coiled flat or wire spring 62 integral with or connected to an arm 63 is attached to said frame such that said arm 63 may pivot around one end thereof opposite the free end thereof. The arm 63 abuts a pin 64 on the body 57.

A pawl 65 is pivotably arranged on a pivot 66 and is biased by a tension spring 67 so as to constantly abut the rim of the gear 55.

In use, the gear 55 is turned clock-wise by the body 57 being displaced from the full line position to the dotted line position thereof by the force of the spring 62 acting through the intermediate arm 63 on the pin 64, whereby the gear advances the width of one tooth 59 and the pawl 65 moves from locking engagement between one pair of teeth 59 to a locking position between the next pair of teeth in the counter clock-wise direction.

When the gear is locked against rotating counter clock-wise by the pawl 65, the SMA wire 60 is heated and shortens whereby the body is displaced from the dotted line position to the full line position against the force of the intermediate arm 63 on the pin 64 thereby cocking the spring 62.

The lever or moment arm of the displacement force exerted by the intermediate arm in the clock-wise direction with respect to the pivoting point of the arm decreases as the body is displaced in the activating direction from the full line position to the dotted line position whereby the displacement force exerted by the intermediate arm 63 on the pin 64 increases.

Referring now to FIG. 9, a SMA actuator motor similar to the motor of FIG. 8 is shown, the spring 62 and intermediate arm 63 being substituted by a tension spring 68 fastened to the body 57 and to a fixed portion 69 of a not shown frame.

The operation of the motor of FIG. 9 is very similar to the one in FIG. 8 except that the displacement force exerted on the body 57 by the spring 68 is exerted directly and declines substantially proportionally with the distance of displacement.

Referring now to FIG. 10, a rack 70 is arranged displaceable in a not shown frame in the direction R4 and a body 71 is arranged displaceable in the directions R3 and R4 as well as transversely thereto. A SMA wire 72 is attached to the body 71 and to a fixed portion 73 of said frame. A coil spring 74 attached to said frame and integral with or connected to an intermediate arm 75 exerts a displacement force on a pin 76 of the body 71 through the intermediate arm 75 in a manner very similar to spring 62 in FIG. 8.

The rack 70 advances the distance of the width of one tooth 78 thereof in the direction R4 for every cycle of heating and cooling of the SMA wire 72 in the same way as gear 55 in FIG. 8 is rotated by wire 60, spring 62, intermediate arm 63 and body 57 in FIG. 8.

The rack 70 may be used to push an object by means of front end 77, for instance a piston in a cylinder to empty said cylinder of liquid or paste through an aperture in said cylinder.

Means to displace the body 71 transversely to the rack 70 may be provided for allowing the rack to be displaced in the direction R3 for repeating the pushing travel of the rack 70 in the direction R4.

Referring now to FIG. 11, the curve or line 80 indicates the relationship between the force exerted by the SMA wire 60 in FIG. 9 on the body 57 as a function of the contraction or shortening thereof. The force increases proportionally with the contraction because of the proportional increase of the spring force of the spring 68 when it is stretched by contraction of the wire 60.

The line or curve 81 is symbolic of the curves corresponding to the relationship between contraction and force exerted for the embodiments of FIGS. 1-8 and 9 where the force in the wires 10, 22, 24 31, 60 and 72, respectively is largest at the beginning of the contraction or shortening, and the contraction length of the wire is much larger because of the variation in the length of the moment arm or arms during the activating stroke as described above.

In this manner, a high coefficient of mechanical efficiency is obtained because the longer contraction distance for a given input of energy to heat the SMA wires gives an increased input of energy into the activating system.

The actual curves 81 will not be linear but will reflect the varying rate of change of the moment arm or moment arms during the activating stroke.

Referring now to FIG. 12 and FIGS. 5-7, an actuator as shown in FIGS. 5-7 is applied to operate a piston pump by depressing the plunger thereof with the body 30.

The pump piston plunger and body 30 travel from 0.2 mm to 3.4 mm during the activating stroke of the body 30. The force required to displace the plunger increases substantially proportionally from approx. 0.5 N to approx. 2N where the force increases steeply because the plunger has reached the end of its path.

The force exerted by the spring 43 on the body 30 and thus the plunger develops as an increasing parable-like curve corresponding to the curve for the tension or force in the SMA wire 31 necessary to retract the body 30 against the leveraged force of the spring 43.

It is clear that the curves show that the actuator according to the invention can produce an increasing force as the displacement increases which is very advantageous in many applications such as pumping with piston pumps where the force required increases with the distance travelled by the plunger.

1. A shape memory alloy actuator comprising:
a body displaceable between a first and a second position,
releasable holding means adapted for holding said body in said first position,
at least one first and at least one second wire made of a shape memory alloy such as nitinol, said first wire being at one end connected to said body such that shortening of the length of said first wire exerts a force on said body for moving said body from said second to said first position, and
a biasing means, selected from the group consisting of at least one of a tension spring, a compression spring, a flat spring and a piston and cylinder mechanism, arranged and adapted for biasing said body for moving said body from said first to said second position,
said second wire having one end connected to said holding means such that shortening of the length of said second wire releases said holding means for allowing said biasing means to move said body from said first position to said second position.

2. An actuator according to claim 1 and further comprising means for intermittently directing an electric current through at least one of said first and second wires for heating said wires to at least the shape memory alloy transformation temperature.

3. An actuator according to claim 1, wherein said holding means comprises a pivotable hook or pawl arranged pivotable between a holding position with said pawl received in a recess in said body and a release position with said pawl disengaged from said recess.

4. An actuator according to claim 3, wherein said body is displaceably attached to a frame, one end of each of said first and second wires is attached to said frame and connected at the other end thereof with said body and said pawl, respectively, such that shortening of the length of said first wire exerts a displacing force on said body in a first direction and shortening of the length of said second wire exerts a pivoting force on said pawl in the direction from said holding position towards said release position, and said biasing means is attached to said frame and arranged for exerting a displacing force on said body in a second direction opposite said first direction.

5. An actuator according to claim 4, wherein said biasing means is arranged and adapted to exert a rotation force on a rotatably arranged intermediate member for rotating said intermediate member around an axis of rotation in a first direction of rotation from a first angular position to a second angular position, said intermediate member being connected to said body at a force transmission point such that rotation of said intermediate member in said first direction of rotation displaces said body in said second direction.

6. An actuator according to claim 5, wherein said biasing means and said intermediate member are arranged and adapted such that the lever or moment arm of said rotation force with respect to said axis of rotation is larger when said intermediate member is in said second angular position than when said intermediate member is in said first angular position such that said lever or moment arm of said rotation force increases when said intermediate member rotates in said first direction of rotation, and wherein said intermediate member and said body are arranged and adapted such that said rotation force is transmitted to said body as a displacement force applied at said force transmission point for moving said body from said first to said second position, and such that the lever or moment arm of said displacement force with respect to said axis of rotation is larger when said intermediate member is in said first angular position than when said intermediate member is in said second angular position such that said lever or moment arm of said displacement force with respect to said axis of rotation decreases when said intermediate member rotates in said first direction of rotation.

7. An actuator according to claim 6, wherein said intermediate member is a two armed lever having one arm connected to said biasing means, and the other arm connected to said body.

8. An actuator according to claim 1, wherein said first wire extends from said end connected to said body around at least one pulley or roller and on to the opposite end of said first wire attached to a fixed point such that a given length of said first wire is accommodated in a limited space.

9. An actuator according to claim 3, wherein a pawl biasing means is arranged and adapted for urging said pivotable pawl from said release position towards said holding position.

10. A shape memory alloy actuator comprising:
a body displaceable between a first and a second position,
at least one first wire made of a shape memory alloy such as nitinol, said first wire being at one end connected to said body such that shortening of the length of said first wire exerts a force on said body for moving said body from said second to said first position,
a biasing means selected from the group consisting of at least one of a tension spring, a compression spring, a flat spring and a piston and cylinder mechanism, and
a rotatably arranged intermediate member connected to said body and to said biasing means,
said biasing means being adapted for exerting a rotation force on said intermediate member for rotating said intermediate member around an axis of rotation in a first direction of rotation from a first angular position to a second angular position, said intermediate member being connected to said body such that rotation of said intermediate member in said first direction of rotation displaces said body from said first position to said second position, and
said biasing means and said intermediate member being arranged and adapted such that the lever or moment arm of said rotation force with respect to said axis of rotation is larger when said intermediate member is in said second angular position than when said intermediate member is in said first angular position such that said lever or moment arm of said rotation force increases when said intermediate member rotates in said first direction of rotation.

11. A shape memory alloy actuator comprising:
a body displaceable between a first and a second position,
at least one first wire made of a shape memory alloy such as nitinol, said first wire being at one end connected to said body such that shortening of the length of said first wire exerts a force on said body for moving said body from said second to said first position,
a biasing means selected from the group consisting of at least one of a tension spring, a compression spring, a flat spring and a piston and cylinder mechanism, and
a rotatably arranged intermediate member connected to said body at a force transmission point on said body and connected to or integral with said biasing means,
said biasing means being adapted for exerting a rotation force on said intermediate member for rotating said intermediate member around an axis of rotation in a first direction of rotation from a first angular position to a second angular position, said intermediate member being connected to said body such that rotation of said intermediate member in said first direction of rotation displaces said body from said first position to said second position, and
said intermediate member and said body being arranged and adapted such that said rotation force is transmitted to said body as a displacement force applied at said force transmission point for moving said body from said first to said second position, and such that the lever or moment arm of said displacement force with respect to said axis of rotation is larger when said intermediate member is in said first angular position than when said intermediate member is in said second angular position such that said lever or moment arm of said displacement force with respect to said axis of rotation decreases when said intermediate member rotates in said first direction of rotation.

12. An actuator according to claim 10 and further comprising:
releasable holding means adapted for holding said body in said first position, and
at least one second wire made of a shape memory alloy such as nitinol and having one end connected to said holding means such that shortening of the length of said second wire releases said holding means for allowing said biasing means to move said body from said first position to said second position.

13. An actuator according to claim 12, wherein said holding means comprises a pivotable hook or pawl arranged pivotable between a holding position with said pawl received in a recess in said body and a release position with said pawl disengaged from said recess.

14. An actuator according to claim 13, wherein said body is displaceably attached to a frame, one end of each of said first and second wires is attached to said frame and connected at the other end thereof with said body and said pawl, respectively, such that shortening of the length of said first wire exerts a displacing force on said body in a first direction and shortening of the length of said second wire exerts a pivoting force on said pawl in the direction from said holding position towards said release position, and said biasing means is attached to said frame and arranged for exerting a displacing force on said body in a second direction opposite said first direction.

15. An actuator according to claim 10 or 11, and further comprising at least one second wire made of a shape memory alloy such as nitinol and having one end connected to said body such that shortening of the length of said first wire exerts a pivoting force on said body in one pivoting direction and shortening of the length of said second wire exerts a pivoting force on said body in the opposite pivoting direction, and said biasing means is attached to said body for exerting a pivoting force on said body in at least one of said pivoting directions.

16. An actuator according to claim 15, wherein said biasing means is arranged for exerting a pivoting force on said body in both said pivoting directions with a balance point between said first and second position of said body wherein said biasing means does not exert a pivoting force on said body.

17. An actuator according to claim 10 and further comprising means for intermittently directing an electric current through said first and/or second wires for heating same to at least the shape memory alloy transformation temperature.

18. A shape memory alloy motor comprising:
a shape memory alloy actuator, having
a body displaceable between a first and a second position,
at least one first wire made of a shape memory alloy such as nitinol, said first wire being at one end connected to said body such that shortening of the length of said first wire exerts a first displacement force on said body for moving said body from said second to said first position,
a biasing means selected from the group consisting of at least one of a tension spring, a compression spring, a flat spring and a piston and cylinder mechanism arranged and adapted for exerting a second displacement force on said body for moving said body from said first to said second position,
a gear having a first and second rotation direction,
said body having a portion adapted to fit between two adjacent teeth of said gear, and said body and said gear being adapted and arranged such that in said first position said portion is located between a pair of teeth of said gear and in said second position said portion is located between the adjacent pair of teeth of said gear reckoned in said second rotation direction of said gear such that said second displacement force will cause said body to rotate said gear in said first direction.

19. A motor according to claim 18 and further comprising a pawl member displaceable between a locking position between a pair of teeth of said gear for preventing rotation of said gear in said second direction and a release position.

20. A shape memory alloy motor comprising:
a shape memory alloy actuator, having
a body displaceable between a first and a second position,
at least one first wire made of a shape memory alloy such as nitinol, said first wire being at one end connected to said body such that shortening of the length of said first wire exerts a first displacement force on said body for moving said body from said second to said first position,
a biasing means selected from the group consisting of at least one of a tension spring, a compression spring, a flat spring and a piston and cylinder mechanism arranged and adapted for exerting a second displacement force on said body for moving said body from said first to said second position,
a rack having a first and second displacement direction,
said body having a portion adapted to fit between two adjacent teeth of said rack, and said body and said rack being adapted and arranged such that in said first position said portion is located between a pair of teeth of said rack and in said second position said portion is located between the adjacent pair of teeth of said gear reckoned in said second displacement direction of said rack such that said second displacement force will cause said body to displace said rack in said first direction.

21. An actuator according to claim 11, and further comprising:
releasable holding means adapted for holding said body in said first position; and
at least one second wire made of a shape memory alloy such as nitinol and having one end connected to said holding means such that shortening of the length of said second wire releases said holding means for allowing said biasing means to move said body from said first position to said second position.

22. An actuator according to claim 21, wherein said holding means comprises a pivotable hook or pawl arranged pivotable between a holding position with said pawl received in a recess in said body and a release position with said pawl disengaged from said recess.

23. An actuator according to claim 22, wherein said body is displaceably attached to a frame, one end of each of said first and second wires is attached to said frame and connected at the other end thereof with said body and said pawl, respectively, such that shortening of the length of said first wire exerts a displacing force on said body in a first direction and shortening of the length of said second wire exerts a pivoting force on said pawl in the direction from said holding position towards said release position, and said biasing means is attached to said frame and arranged for exerting a displacing force on said body in a second direction opposite said first direction.

24. An actuator according to claim 11, and further comprising at least one second wire made of a shape memory alloy such as nitinol and having one end connected to said body such that shortening of the length of said first wire exerts a pivoting force on said body in one pivoting direction and shortening of the length of said second wire exerts a pivoting force on said body in the opposite pivoting direction, and said biasing means is attached to said body for exerting a pivoting force on said body in at least one of said pivoting directions.

25. An actuator according to claim 24, wherein said biasing means is arranged for exerting a pivoting force on said body in both said pivoting directions with a balance point between said first and second position of said body wherein said biasing means does not exert a pivoting force on said body.

26. An actuator according to claim 11, and further comprising means for intermittently directing an electric current through said first and/or second wires for heating same to at least the shape memory alloy transformation temperature.
